(19) United States
(12) Patent Application Publication
(10) Pub. No.: US 2024/0156080 A1
(43) Pub. Date: May 16, 2024

(54) Window for Reducing Bird Collisions

(71) Applicant: Vitro Flat Glass LLC, Cheswick, PA (US)

(72) Inventors: Martin Bracamonte, Jupiter, FL (US); James W. McCamy, Export, PA (US); Erin A. Casci, Pittsburgh, PA (US)

(21) Appl. No.: 18/505,435

(22) Filed: Nov. 9, 2023

Related U.S. Application Data
(60) Provisional application No. 63/424,603, filed on Nov. 11, 2022.
(60) Provisional application No. 63/522,826, filed on Jun. 23, 2023.

(51) Int. Cl. A01M 29/10; C03C 23/00; E06B 3/66

(52) U.S. Cl. CPC A01M 29/10; C03C 23/0025; E06B 3/6612

(57) ABSTRACT

A window includes: a first transparent panel including an exterior-facing No. 1 surface and an opposing No. 2 surface, a second transparent panel including an interior-facing No. 4 surface and an opposing No. 3 surface, where the first transparent panel and the second transparent panel are spaced apart from one another by a gap, where the No. 1 surface includes a pattern having a plurality of markings spaced at the No. 1 surface, where each of the plurality of markings include an abrasion, thereby leaving a visible marking at the No. 1 surface.

### CROSS-REFERENCE TO RELATED APPLICATIONS

This application claims priority to U.S. Provisional Patent Application No. 63/424,603, filed Nov. 11, 2022, and U.S. Provisional Patent Application No. 63/522,826, filed Jun. 23, 2023, the disclosures of which are hereby incorporated by reference in their entireties.

### BACKGROUND

### Field

The present disclosure is directed to a window and, in some non-limiting embodiments or aspects, a window having visible abrasions at the No. 1 surface for reducing bird collisions.

### Technical Considerations

To reduce energy losses and improve comfort in buildings, windows with high thermal performance are needed. However, it is estimated that 1 billion birds die in the United States each year after collisions with windows. The collisions are caused due to the fact that the substrate of the window reflects the sky and landscape behind the bird, such that the bird perceives that its flight path is open. Windows that reduce bird collisions are desired.

### SUMMARY OF THE DISCLOSURE

According to some non-limiting aspects of the disclosure, a window includes: a first transparent panel including an exterior-facing No. 1 surface and an opposing No. 2 surface, a second transparent panel including an interior-facing No. 4 surface and an opposing No. 3 surface, where the first transparent panel and the second transparent panel are spaced apart from one another by a gap, where the No. 1 surface includes a pattern including a plurality of markings spaced at the No. 1 surface, where each of the plurality of markings include an abrasion, thereby leaving a visible marking at the No. 1 surface.

In some non-limiting aspects, the abrasions may be laser-induced markings formed by applying a laser beam to the No. 1 surface to remove at least a portion of material of the No. 1 surface or produce microcracks beneath the No. 1 surface. The abrasions may be formed by sandblasting the No. 1 surface to remove at least a portion of material of the No. 1 surface. The abrasions may be formed by removing at least a portion of material of the No. 1 surface. The abrasions may be formed by producing microcracks beneath the No. 1 surface. The No. 1 surface may be an uncoated surface and/or a coated surface. The laser-induced markings may be formed by a carbon dioxide laser. The laser beam may have an energy density of from 0.5 J/cm² to 10 J/cm² at a location of a marking formed by the laser beam. Each of the plurality of markings may scatter incident electromagnetic radiation. The gap may be sealed closed by an edge connecting the first panel and the second panel. The gap may include a gas denser than air. The gap may be evacuated to produce a vacuum.

In some non-limiting aspects, the window may further include a plurality of supports arranged in the gap to connect the first panel and the second panel. At least a portion of the plurality of markings may be formed between locations in which the plurality of supports contact the first panel. At least a portion of the plurality of markings may be formed at locations in which the plurality of supports contact the first panel. The first panel may be a component of a building integrated photovoltaic (BIPV) component. The window may be arranged in a frame of an architectural structure with the exterior-facing No. 1 surface arranged as an exterior surface of the architectural structure. The gap may be sealed closed by an edge connecting the first panel and the second panel, where the plurality of markings may be formed by applying the laser beam to the No. 1 surface after the gap is sealed closed. The plurality of markings may not be formed by chemical etching unassisted by any photon enhanced reaction. The plurality of markings may exhibit a 20° gloss value of less than 1. The pattern may be spaced over the entire area of the No. 1 surface such that there is no four square inch area of the No. 1 surface without a marking of the plurality of markings. The first panel may include glass and/or plastic.

According to some non-limiting aspects of the disclosure, an architectural structure includes the window described herein.

In some non-limiting aspects, the architectural structure may include a building comprising an opening, where the window is mounted in the opening with the exterior-facing No. 1 surface arranged as an exterior surface of the building.

According to some non-limiting aspects of the disclosure, a method of manufacturing a window includes: providing an insulated transparency unit including a first transparent panel including an exterior-facing No. 1 surface and an opposing No. 2 surface and a second transparent panel including an interior-facing No. 4 surface and an opposing No. 3 surface, where the first transparent panel and the second transparent panel are spaced apart from one another by a gap; and forming a pattern at the No. 1 surface, where the pattern includes a plurality of markings spaced at the No. 1 surface, where each of the plurality of markings includes an abrasion, thereby leaving a visible marking at the No. 1 surface.

In some non-limiting aspects, the patterning may include removing at least a portion of material of the No. 1 surface or producing microcracks beneath the No. 1 surface using a laser beam. The method may further include sealing the gap closed by forming an edge connecting the first panel and the second panel, where the plurality of markings are formed at the No. 1 surface after the gap is sealed closed. The gap may be filled with a gas denser than air. The gap may include a vacuum.

According to some non-limiting aspects of the disclosure, a method of preventing bird collisions with an architectural substrate includes installing the window described herein in an opening of an architectural substrate with the exterior-facing No. 1 surface arranged as an exterior surface of the architectural substrate.

### BRIEF DESCRIPTION OF THE DRAWINGS

The disclosure will be described with reference to the following drawing figures wherein like reference numbers identify like parts throughout.

FIG. 1A shows a top view of a first panel of a window having a first pattern, according to some aspects of the disclosure;

FIG. 1B shows a top view of a first panel of a window having a second pattern, according to some aspects of the disclosure;

FIG. 1C shows a top view of a first panel of a window having a third pattern, according to some aspects of the disclosure;

FIG. 2A shows a cross-sectional view of a vacuum filled dual-pane window having markings in the form of removal abrasions at the No. 1 surface, according to some aspects of the disclosure;

FIG. 2B shows a cross-sectional view of a vacuum filled dual-pane window having markings in the form of subsurface abrasions at the No. 1 surface, according to some aspects of the disclosure;

FIG. 2C shows a cross-sectional view of a gas filled dual-pane window having markings in the form of removal abrasions at the No. 1 surface, according to some aspects of the disclosure;

FIG. 2D shows a cross-sectional view of a gas filled dual-pane window having markings in the form of subsurface abrasions at the No. 1 surface, according to some aspects of the disclosure;

FIG. 3 shows a schematic view of an architectural structure comprising a window, according to some aspects of the disclosure;

FIG. 4 shows a perspective view of a vacuum insulating glass (VIG) window unit, according to some aspects of the disclosure;

FIG. 5 shows a cross-sectional view of a vacuum insulating glass (VIG) window unit, according to some aspects of the disclosure;

FIG. 6 shows a schematic view of a laser inducing a marking in the form of a removal abrasion at the No. 1 surface, according to some aspects of the disclosure;

FIG. 7 shows a schematic view of a marking in the form of a removal abrasion at the No. 1 surface emitting scattered radiation, according to some aspects of the disclosure;

FIG. 8A shows a cross-sectional view of a single-pane window having markings in the form of removal abrasions at the No. 1 surface, according to some aspects of the disclosure;

FIG. 8B shows a cross-sectional view of a single-pane window having markings in the form of subsurface abrasions at the No. 1 surface, according to some aspects of the disclosure;

FIG. 9 shows a cross-sectional view of a side-lit vacuum filled dual-pane window having markings in the form of removal abrasions at the No. 1 surface, according to some aspects of the disclosure;

FIG. 10 shows a photograph of a VIG unit having a first panel having a pattern at the No. 1 surface, according to some aspects of the disclosure;

FIG. 11 shows a photograph of a VIG unit having a first panel having a pattern at the No. 1 surface, according to some aspects of the disclosure; and

FIG. 12 shows a photograph of a unit having the No. 1 surface coated, wherein the No. 1 surface was patterned by removing portions of the coating using a diode laser (λ=390 nm).

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Additionally, all documents, such as, but not limited to, issued patents and patent applications, referred to herein are to be considered to be “incorporated by reference” in their entirety.

The present disclosure is directed to a window comprising: a first panel comprising an exterior-facing No. 1 surface and an opposing No. 2 surface, a second panel comprising an interior-facing No. 4 surface and an opposing No. 3 surface, wherein the first panel and the second panel are spaced apart from one another by a gap, wherein the No. 1 surface comprises a pattern comprising a plurality of markings spaced at the No. 1 surface, wherein each of the plurality of markings comprise an abrasion, thereby leaving a visible marking at the No. 1 surface.

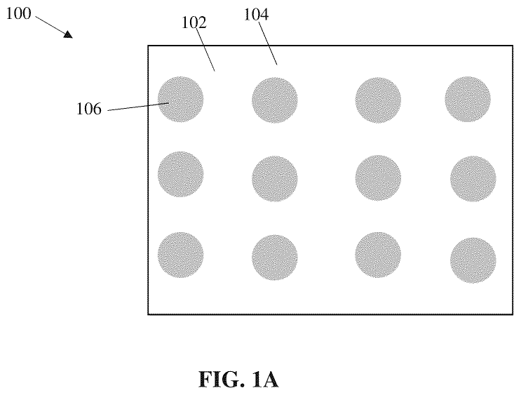

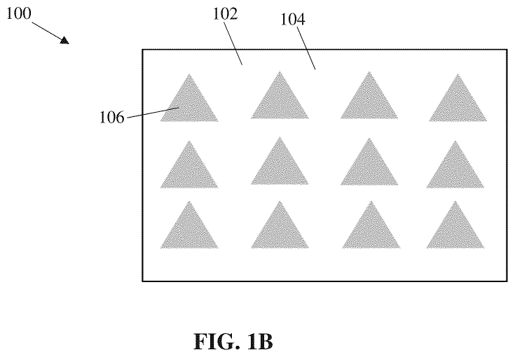

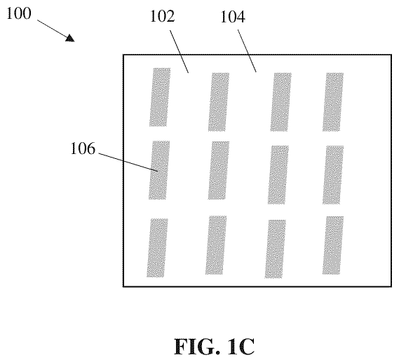

Referring to FIG. 1A-1C, window 100 is shown having a first panel 102 having a pattern according to some non-limiting embodiments or aspects. The pattern comprises a plurality of visible markings 106 at a first major surface (No. 1 surface 104). The pattern may comprise any arrangement of the plurality of visible markings 106. The pattern distribution can be periodic, quasi-periodic, or random. The markings 106 may be of any shape (e.g., circles, triangles, parallelograms), or any other conceivable design of markings 106. The pattern may comprise a plurality of markings 106 spaced over the No. 1 surface 104. The pattern may be spaced over the entire area of the No. 1 surface 104 such that there is no four square inch area of the No. 1 surface 104 without a marking 106. The pattern being spaced over the entire area of the No. 1 surface may contribute to the window 100 reducing bird collisions, as the markings 106 are visible to the birds. Ensuring that there is no four square inch area of the No. 1 surface 104 without a marking 106 may make it such that a bird of any size flying toward the window 100 perceives the window 100 and does not mistake a gap between markings for an area in which the bird can fly through. In certain embodiments, wherein the birds involved are larger, the pattern may be such that the spacing is a six-, eight-, or 10-square inch area or larger.

With continued reference to FIGS. 1A-1C, the markings 106 may be visible to birds. The markings 106 may be visible to both birds and humans, such that they are visible by reflecting radiation in the visible region (approximately 380-750 nm) of the electromagnetic spectrum. The markings may exhibit a low gloss value at 20°, such as the markings 106 having a 20° gloss value of less than 1 gloss unit, less than 0.5 gloss units, or less than 0.25 gloss units. 20° gloss value may be measured using a gloss meter.

The No. 1 surface 104 may be an uncoated surface. Alternatively, the No. 1 surface 104 may be coated, such as with a solar control coating, a protective coating, or any other type of coating.

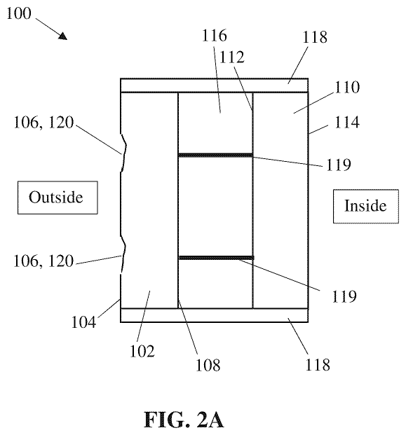

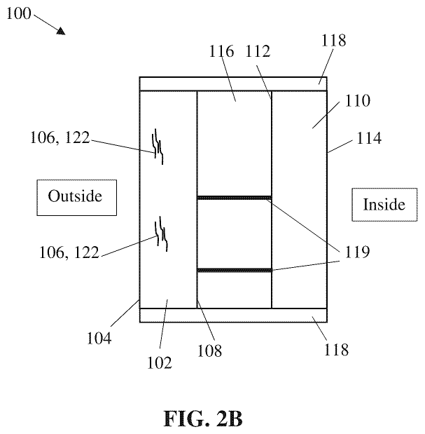

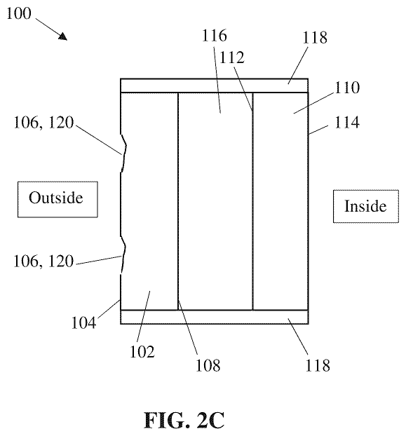

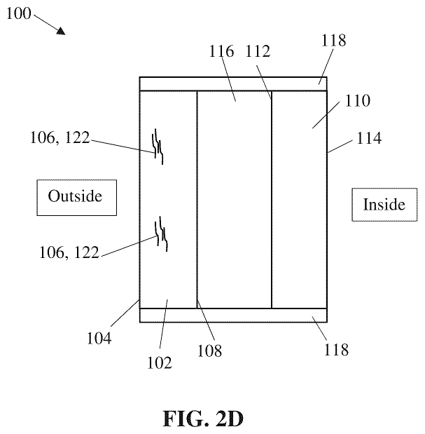

The plurality of visible markings 106 are arranged at the No. 1 surface 104. Each marking 106 may comprise an abrasion at the No. 1 surface 104. The phrase “at the No. 1 surface” refers to the abrasion being on the No. 1 surface 104 or subsurface to (under) the No. 1 surface, as will be shown and described in connection with FIGS. 2A-2B. An “abrasion” refers to an alteration to the first panel 102 at the location of the marking 106.

Referring to FIGS. 2A-2B, dual-pane window 100 is shown having markings 106 at the No. 1 surface 104, according to some non-limiting embodiments or aspects. While FIGS. 2A-2B shows a dual-pane window 100, it will be appreciated that the window 100 may have additional panes, such as 3 panes or 4 panes. Alternatively, the window 100 may have only a single pane. In the non-limiting embodiments of FIGS. 2A-2B, the window 100 comprises a first panel 102 comprising the No. 1 surface 104, which is exterior facing, and an opposing second major surface (No. 2 surface 108). The window may also comprise a second panel 110 comprising an interior-facing fourth major surface (No. 4 surface 114) and an opposing third major surface (No. 3 surface 112). The first panel 102 and the second panel 110 may be spaced apart from one another by a gap 116 (e.g. the gap between the No. 2 surface 108 and the No. 3 surface 112).

Non-limiting examples of the window 100 in FIGS. 2A-2B are in the form of insulating glass units that include the first panel 102 with the No. 1 surface 104 and an opposed No. 2 surface 108 installed in a building. In the illustrated non-limiting embodiment, the No. 1 surface 104 faces the building exterior, i.e., is an outer major surface, and the No. 2 surface 108 faces the interior of the building. The window 100 also includes the second panel 110 having an outer (first) No. 3 surface 112 and an inner (second) No. 4 surface 114. This numbering of the panel surfaces is in keeping with conventional practice in the fenestration art.

The first and second panels 102, 110 can be connected together in any suitable manner, such as by being adhesively bonded to a conventional spacer frame 118. The gap 116 is formed between the two panels 102, 110. The gap may be evacuated to produce a vacuum (a vacuum insulating glass unit). Examples of insulating glass units are found, for example, in U.S. Pat. Nos. 4,193,236; 4,464,874; 5,088,258; and 5,106,663.

The first and second panels 102, 110 can comprise glass or plastic.

The first and second panels 102, 110 can comprise glass. Non-limiting examples of suitable glass materials for the first and second panels 102, 110 include soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as float glass, and can be of any composition having any optical properties, e.g., any value of visible transmission, ultraviolet transmission, infrared transmission, and/or total solar energy transmission. By “float glass” is meant glass formed by a float process in which molten glass is deposited onto a molten metal bath and controllably cooled to form a float glass ribbon.

The first and second panels 102, 110 can comprise plastic. Non-limiting examples of suitable plastic materials for the first and second panels 102, 110 include acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof).

The first and second panels 102, 110 can be of any desired dimensions, e.g., length, width, shape, or thickness. In one non-limiting embodiment in which the first and second panels 102, 110 are components in an architectural transparency, each of the first and second panels 102, 110 may be 1-30 mm thick, such as 2.5-25 mm thick, or 2.5-10 mm. In one non-limiting embodiment in which the first and second panels 102, 110 are components in an automotive transparency, each of the first and second panels 102, 110 may be 1-10 mm thick, such as 1-8 mm thick, 2-8 mm, 3-7 mm, 5-7 mm, or 4-6 mm thick.

Referring to FIG. 2A, the window 100 comprises a plurality of markings 106 at the No. 1 surface 104. The markings 106 may be on the No. 1 surface 104 as shown in FIG. 2A, and such markings 106 may be removal abrasions 120 formed by removing at least a portion of material from the original No. 1 surface 104 (an alteration to the first panel 102 at the location of the marking 106), thereby forming a visible marking 106.

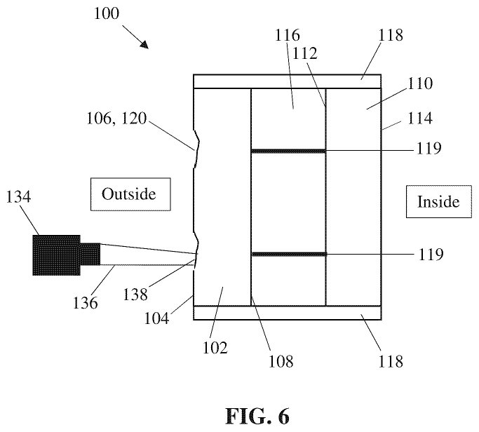

Referring to FIGS. 2A and 6, the removal abrasion 120 may be laser-induced by applying a laser 134 to the No. 1 surface 104 to remove at least a portion of material of the No. 1 surface 104. The laser 134 may be any laser 134 emitting a beam 136 of sufficient energy density to produce the removal abrasion 120. For example, the removal abrasion 120 may be formed by a carbon dioxide laser, a yttrium aluminum garnet (YAG) laser, a frequency doubled YAG laser, a fiber laser, a diode laser, an excimer laser, and the like. For example, the laser 134 (e.g., the beam 136 thereof) may have an energy density of from 0.5 J/cm² to 10 J/cm² at the location of the marking 106 (the removal abrasion 120) being formed thereby. The energy density will depend on the specific laser used but may preferably be in the range 0.75 J/cm² to 5 J/cm². For example, the beam 136 of the laser 134 may have a contact beam waist 138 of less than 1 mm at the location of the marking 106 (the removal abrasion 120) being formed thereby. A larger beam waist can be used if the laser output is such that the energy density is above the threshold required for material removal or damage.

Referring again to FIG. 2A, the removal abrasion 120 may be formed by sandblasting the No. 1 surface 104 to remove at least a portion of material of the No. 1 surface 104, thereby forming a visible marking 106. Other means of mechanically abrading the surface may also be used (e.g., a diamond grit coated pad at high rotational speed pressed against the surface).

Referring to FIG. 2B, the window 100 comprises a plurality of markings 106 at the No. 1 surface 104. The markings 106 may be under the No. 1 surface 104 as shown (in the first panel 102 between the No. 1 surface 104 and the No. 2 surface 108), and such markings 106 may be produced as subsurface abrasions 122, such as microcracks (e.g., an alteration to the first panel 102 at the location of the marking 106). The subsurface abrasions 122 may be laser-induced by applying a laser beam to the No. 1 surface 104 to produce subsurface abrasions 122 subsurface to the No. 1 surface 104. The laser beam may have the same characteristics as the laser beam used to form removal abrasions 120 in FIGS. 2A and 6, with the laser type, energy density, and beam waist being selected to produce the microcracks subsurface to the No. 1 surface 104, for example, without damaging other sections of the first panel 102.

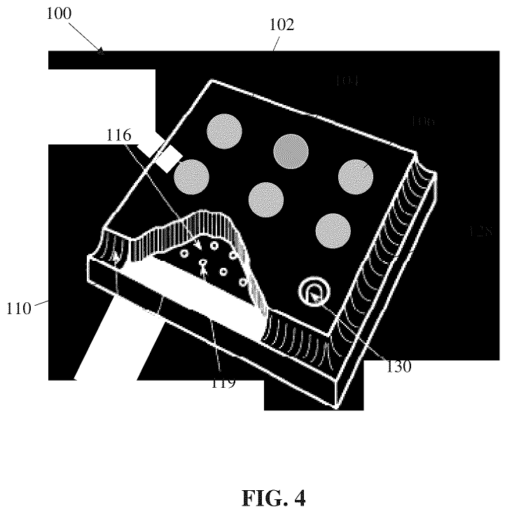

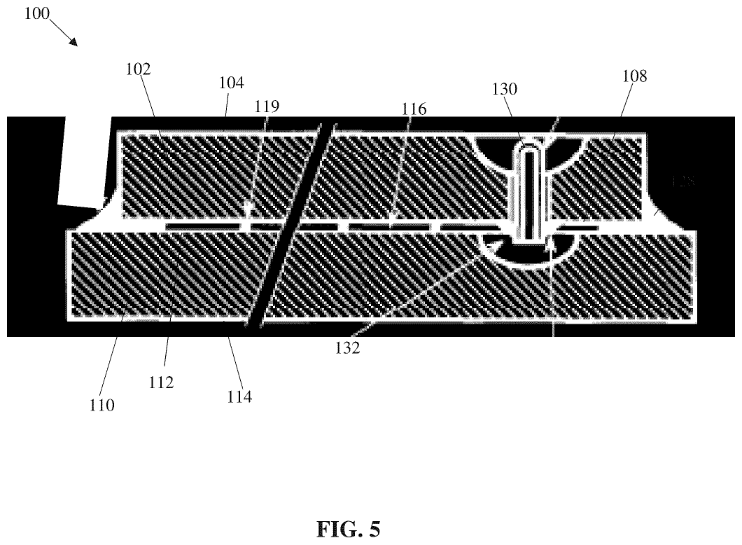

Referring to FIGS. 2A, 2B, and 6, the markings 106 at the No. 1 surface 104 may not be formed by chemical etching unassisted by any photon enhanced reaction. Forming the markings 106 as described herein and without chemical etching may avoid damage to the window 100, and may particularly avoid damage to the edge 128, described hereinafter in FIGS. 4-5.

Referring again to FIGS. 2A-2B and referring to FIGS. 4-5, a plurality of supports 119 may be arranged in the gap 116 to connect the first panel 102 and the second panel 110. The supports 119 may provide additional strength to the window 100. The supports 119 may provide additional strength to the window 100 having the gap 116 filled with a gas. Alternatively, the supports 119 may provide additional strength to the window 100 having the gap 116 that is a vacuum. In some non-limiting embodiments or aspects, the supports 119 may be arranged in pattern, with supports 119 spaced apart by approximately 20-70 mm², such as 30-60 mm², or 50 mm², in order to provide adequate support to the first panel 102 and the second panel 110.

Referring again to FIG. 2A, at least a portion of the plurality of markings 106 may be formed at locations in which the supports 119 contact the first panel 102 (e.g., the No. 2 surface 108 thereof). In some non-limiting embodiments or aspects, each of the supports 119 may be arranged to contact the first panel 102 at a location of a marking 106.

Referring again to FIG. 2B, at least a portion of the plurality of markings 106 may be formed between locations in which the supports 119 contact the first panel 102 (e.g., the No. 2 surface 108 thereof). In some non-limiting embodiments or aspects, each of the supports 119 may be arranged to contact the first panel 102 at a location between markings 106.

Referring to FIGS. 2C and 2D, the windows 100 shown therein are the same as the windows shown in FIGS. 2A and 2B, respectively, except as follows. The gap 116 can be filled with a selected atmosphere, such as air, or a non-reactive gas such as argon or krypton gas. The gas filling the gap 116 may be denser than air. Because the gap 116 is filled with a selected atmosphere (instead of being vacuum filled), the windows 100 may omit supports 119 included in the windows 100 from FIGS. 2A and 2B.

Additionally or alternatively to being vacuum filled or gas filled, the gap 116 may contain a liquid, gel, solid, or combination thereof. The gap may also contain a mechanical structure such as movable blinds.

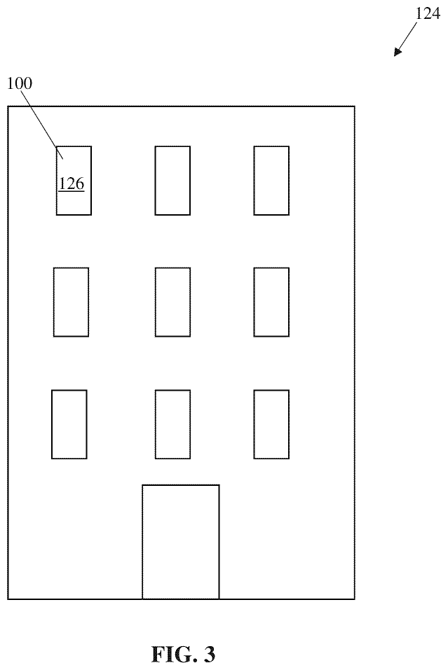

Referring to FIG. 3, an architectural structure 124 is shown in which the architectural structure 124 comprises at least one window 100 described herein. The architectural structure 124 may comprise an opening 126, wherein the window 100 is mounted in the opening 126 with the exterior-facing No. 1 surface 104 (not shown) of the window 100 arranged as an exterior surface of the architectural structure 124. The architectural structure 124 may be a building, such as a residential or commercial building. The window 100 may be used in the building as a window or skylight of the building. The window 100 comprising the first panel 102 (not shown) may be a component of a building integrated photovoltaic (BIPV) component.

Referring to FIGS. 4-5, in some non-limiting embodiments or aspects, the window 100 may comprise a vacuum insulating glass (VIG) unit. The VIG unit may comprise the first panel 102 spaced apart from the second panel 110 to form the gap 116. Supports 119 may be arranged in the gap 116 to connect the first panel 102 and second panel 110 to provide additional support thereto. The visible markings 106 may be arranged at the No. 1 surface 104. An edge 128 may be arranged around a perimeter of the window 100 to connect the edges of the first panel 102 and the second panel 110 to seal the gap 116 closed. The edge 128 may be soldered to seal the gap 116 closed. The edge 128 may prevent gas from entering or leaving the gap 116 by the perimeter between the first panel 102 and the second panel 110.

With continued reference to FIGS. 4-5, the VIG unit may comprise a pump out tube 130 and a pump out cavity 132 for evacuating the gap 116 after the edge 128 between the first panel 102 and the second panel 110 has been formed to seal the gap 116. The pump out tube 130 may comprise a first end arranged in the gap 116 and/or the pump out cavity 132 and a second end protruding from a surface of the first panel 102 and/or the second panel 110. The pump out cavity 132 may comprise at least a portion of the region of the gap 116 in which the first end of the pump out tube 130 is arranged and/or a portion of a region cut out from the No. 2 surface 108 and/or the No. 3 surface 112 of the first panel 102 and/or the second panel 110.

The pump out tube 130 and a pump out cavity 132 may be used to evacuate the gap 116 after the edge 128 between the first panel 102 and the second panel 110 has been formed to seal the gap 116. After the edge 128 between the first panel 102 and the second panel 110 has been formed to seal the gap 116, the gap 116 may contain residual gas (e.g. air), not desired for a VIG unit. The second end of the pump out tube 130 may be opened after the edge 128 is formed to evacuate the residual gas from the gap 116. The gas from the gap 116 may be forced from the gap 116, into the pump out cavity 132, in through the first end of the pump out tube 130, and out through the second end of the pump out tube 130. This procedure may be used to form a vacuum in the gap 116, and thus form the VIG unit.

With continued reference to FIG. 4-5, the markings 106 may be formed (e.g., by applying the laser beam) at the No. 1 surface 104 of the first panel 102 of the VIG unit after the gap 116 is sealed closed by the formation of the edge 128 connecting the first panel 102 and the second panel 110. The markings 106 may be formed as previously described and without chemical etching to avoid damage to the window 100, such as damage to the edge 128.

In some non-limiting embodiments or aspects, the window 100 may be an insulating glass unit in which the gap 116 is filled with a gas with a thermal conductivity lower than air, such as argon. The gap 116 may be filled with the gas heavier than air. For example, the gap 116 may be filled with the gas heavier than air after the edge 128 between the first panel 102 and the second panel 110 has been formed to seal the gap 116 using the pump out tube 130. The gas heavier than air may be flowed into the second end of the pump out tube 130 and out of the first end thereof and into the gap 116. The markings may be formed at the No. 1 surface 104 of the first panel 102 of the window 100 having the gap 116 filled with gas heavier than air after the gap 116 is sealed closed by the formation of the edge 128 connecting the first panel 102 and the second panel 110.

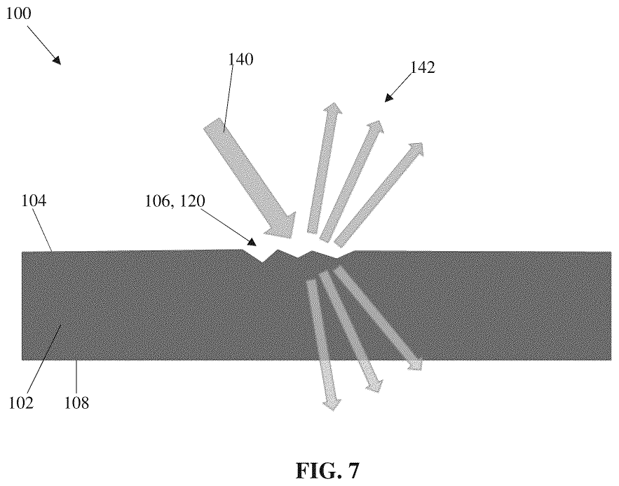

Referring to FIG. 7, the markings 106 spaced at the No. 1 surface 104, leaving visible markings at the No. 1 surface 104, scatter visible incident electromagnetic radiation. In the non-limiting embodiment shown in FIG. 7, a marking 106 (a removal abrasion 120) is formed in the No. 1 surface 104 of the first panel 102. Incoming radiation 140, such as from sunlight or another radiation source, may be incident to the marking 106, such that the incoming radiation 140 collides with the marking 106. The incoming radiation 140 may comprise visible electromagnetic radiation, and may comprise ultraviolet and/or infrared radiation. Upon the incoming radiation 140 colliding with the marking 106, the marking 106 may reflect radiation (i.e., the scattered radiation 142) in at least one direction away from the No. 1 surface 104. The scattered radiation 142 may be scattered. By “scattered”, it is meant that the incoming radiation 140 is reflected in non-specular directions to form the scattered radiation 142. A specular direction is a direction of reflection characteristic of a mirror.

The present disclosure is also directed to a method of manufacturing a window for reducing bird collisions, such as any of the windows described herein. The method of manufacturing includes providing a window (such as an insulating glass unit described herein) comprising a first panel comprising an exterior-facing No. 1 surface and an opposing No. 2 surface and a second panel comprising an interior-facing No. 4 surface and an opposing No. 3 surface, wherein the first panel and the second panel are spaced apart from one another by a gap. The method may further comprise forming a pattern at the No. 1 surface, wherein the pattern comprises a plurality of markings spaced at the No. 1 surface (e.g., over an entire area of the No. 1 surface), wherein each of the plurality of markings comprises an abrasion, thereby leaving a visible marking at the No. 1 surface.

The patterning at the No. 1 surface may comprise removing at least a portion of material from the No. 1 surface or producing microcracks beneath the No. 1 surface using a laser beam as described herein.

The method of manufacturing may further include sealing the gap closed by forming an edge connecting the first panel and the second panel, and the plurality of markings may be formed at the No. 1 surface after the gap is sealed closed. Forming the plurality of markings after the gap is sealed closed may allow for the more efficient formation of the window because the markings may be formed on an otherwise completely manufactured window (as opposed to patterning the No. 1 surface before assembling the window unit). The gap may be filled with a gas denser than air. Alternatively, the gap may comprise a vacuum by evacuating gas in the gap.

The present disclosure is also directed to a method of preventing bird collisions with an architectural substrate comprising a window, such as any of the windows described herein. The method may include installing the window described herein in an opening of an architectural substrate with the exterior-facing No. 1 surface arranged as an exterior surface of the architectural substrate.

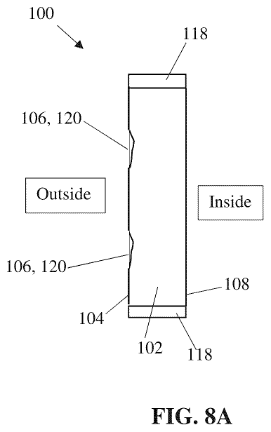

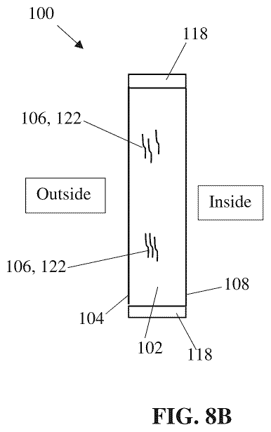

Referring to FIGS. 8A-8B, the windows 100 shown therein are similar to those described in connection with FIGS. 2A-2D except as follows. The windows 100 in FIGS. 8A-8B have a single pane (as opposed to the dual pane windows 100 from FIGS. 2A-2D). Therefore, the windows in FIGS. 8A-8B comprise a first panel 102 having a No. 1 surface 104 and an opposing No. 2 surface 108. The first panel 102 may be arranged between the frame 118 to form the window 100. The first panel 102 may have a pattern comprising a plurality of visible markings 106 at the No. 1 surface 104. In FIG. 8A, the markings 106 comprise removal abrasions 120, while in FIG. 8B, the markings comprise subsurface abrasions 122.

With continued reference to FIGS. 8A-8B, the patterning at the No. 1 surface 104 may comprise removing at least a portion of material from the No. 1 surface or producing microcracks beneath the No. 1 surface 104 using a laser beam as described herein. The windows 100 of FIGS. 8A-8B may be manufactured by forming the markings 106 after the first panel 102 has been arranged in the frame 118 to form the window 100. Forming the markings 106 after the first panel 102 has been arranged in the frame 118 may allow for the more efficient formation of the window 100 because the markings may be formed on an otherwise completely manufactured window (as opposed to patterning the No. 1 surface 104 before assembling the window unit).

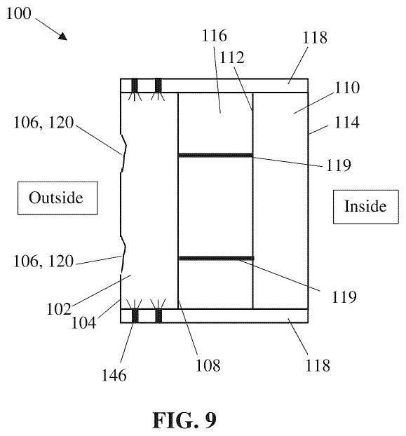

Referring to FIG. 9, the window 100 shown therein is similar to those described in connection with FIGS. 2A-2D except as follows. The window 100 in FIG. 9 may further comprise at least one side light 146. The side light 146 may be positioned on at least one side of the first panel 102, the side being between the No. 1 surface 104 and the No. 2 surface 108. For example, the side light 146 may be integrated into the frame 118 and emit light into the side of the first panel 102. Rays of light emitted from the side light 146 may pass through the interior of the first panel 102, and at least some of the rays of the light may become incident to markings 106 at the No. 1 surface 104. The portion of the light emitted from the side light 146 that becomes incident to the markings 106 may further illuminate the markings 106 making them even more visible than markings 106 not illuminated with light from the side light 146. The markings 106 may redirect the incident light so that the markings 106 appear more visible. Thus, the use of the side light 146 may make the markings 106 even more visible, further preventing bird collisions with the window 100.

Although the side light 146 is shown integrated into the frame 118 of the window 100 having two panels 102, 110 and having removal abrasions 120 as the markings 106, it will be appreciated that the side light 146 may be used for single panel 102 windows 100 (e.g., FIGS. 8A-8B) and/or with subsurface abrasions 122 as the markings 106. Further, although the side light 146 is shown emitting light at a side of the first panel 102, the side light 146 may additionally or alternatively emit light at a side of the second panel 110, which second panel may additionally or alternatively comprise markings 106.

The following numbered clauses are illustrative of various aspects of the disclosure:

Clause 1: A window comprising: a first transparent panel comprising an exterior-facing No. 1 surface and an opposing No. 2 surface, a second transparent panel comprising an interior-facing No. 4 surface and an opposing No. 3 surface, wherein the first transparent panel and the second transparent panel are spaced apart from one another by a gap, wherein the No. 1 surface comprises a pattern comprising a plurality of markings spaced over the No. 1 surface, wherein each of the plurality of markings comprise an abrasion, thereby leaving a visible marking at the No. 1 surface.

Clause 2: The window of clause 1, wherein the abrasions are laser-induced markings formed by applying a laser beam to the No. 1 surface to remove at least a portion of material from the No. 1 surface or produce microcracks beneath the No. 1 surface.

Clause 3: The window of clause 1 or 2, wherein the abrasions are formed by sandblasting the No. 1 surface to remove at least a portion of material from the No. 1 surface.

Clause 4: The window of any of clauses 1-3, wherein the abrasions are formed by removing at least a portion of material from the No. 1 surface.

Clause 5: The window of any of clauses 1-4, wherein the abrasions are formed by producing microcracks beneath the No. 1 surface.

Clause 6: The window of any of clauses 1-5, wherein the No. 1 surface is an uncoated surface and/or a coated surface.

Clause 7: The window of any of clauses 2-6, wherein the laser-induced markings are formed by a carbon dioxide laser.

Clause 8: The window of any of clauses 2-7, wherein the laser beam has an energy density of from 0.5 J/cm² to 10 J/cm² at a location of a marking formed by the laser beam.

Clause 9: The window of any of clauses 1-8, wherein each of the plurality of markings scatter incident electromagnetic radiation.

Clause 10: The window of any of clauses 1-9, wherein the gap is sealed closed by an edge connecting the first panel and the second panel.

Clause 11: The window of any of clauses 1-10, wherein the gap comprises a gas denser than air.

Clause 12: The window of any of clauses 1-11, wherein the gap is evacuated to produce a vacuum.

Clause 13: The window of clause 12, further comprising a plurality of supports arranged in the gap to connect the first panel and the second panel.

Clause 14: The window of clause 13, wherein at least a portion of the plurality of markings are formed between locations in which the plurality of supports contact the first panel.

Clause 15: The window of clause 13 or 14, wherein at least a portion of the plurality of markings are formed at locations in which the plurality of supports contact the first panel.

Clause 16: The window of any of clauses 1-15, wherein the first panel is a component of a building integrated photovoltaic (BIPV) component.

Clause 17: The window of any of clauses 1-16, wherein the window is arranged in a frame of an architectural structure with the exterior-facing No. 1 surface arranged as an exterior surface of the architectural structure.

Clause 18: The window of any of clauses 2-17, wherein the gap is sealed closed by an edge connecting the first panel and the second panel, wherein the plurality of markings are formed by applying the laser beam to the No. 1 surface after the gap is sealed closed.

Clause 19: The window of any of clauses 1-18, wherein the plurality of markings are not formed by chemical etching unassisted by any photon enhanced reaction.

Clause 20: The window of any of clauses 1-19, wherein the plurality of markings exhibit a 20° gloss value of less than 1.

Clause 21: The window of any of clauses 1-20, wherein the pattern is spaced over the entire area of the No. 1 surface such that there is no four square inch area of the No. 1 surface without a marking of the plurality of markings.

Clause 22: The window of any of clauses 1-21, wherein the first panel comprises glass and/or plastic.

Clause 23: The window of any of clauses 1-22, further comprising at least one side light positioned to emit light at a side of the first transparent panel between the No. 1 surface and the No. 2 surface.

Clause 24: An architectural structure comprising the window of any of clauses 1-23.

Clause 25: The architectural structure of clause 24, comprising a building comprising an opening, wherein the window is mounted in the opening with the exterior-facing No. 1 surface arranged as an exterior surface of the building.

Clause 26: A method of manufacturing a window, comprising: providing an insulated transparency unit comprising a first transparent panel comprising an exterior-facing No. 1 surface and an opposing No. 2 surface and a second transparent panel comprising an interior-facing No. 4 surface and an opposing No. 3 surface, wherein the first transparent panel and the second transparent panel are spaced apart from one another by a gap; and forming a pattern at the No. 1 surface, wherein the pattern comprises a plurality of markings spaced at the No. 1 surface, wherein each of the plurality of markings comprises an abrasion, thereby leaving a visible marking at the No. 1 surface.

Clause 27: The method of clause 26, wherein the patterning comprises removing at least a portion of material of the No. 1 surface or producing microcracks beneath the No. 1 surface using a laser beam.

Clause 28: The method of clause 26 or 27, further comprising: sealing the gap closed by forming an edge connecting the first panel and the second panel, wherein the plurality of markings are formed at the No. 1 surface after the gap is sealed closed.

Clause 29: The method of any of clauses 26-28, wherein the gap is filled with a gas denser than air.

Clause 30: The method of any of clauses 26-29, wherein the gap comprises a vacuum.

Clause 31: A method of preventing bird collisions with an architectural substrate, comprising: installing the window of any of clauses 1-23 in an opening of an architectural substrate with the exterior-facing No. 1 surface arranged as an exterior surface of the architectural substrate.

Clause 32: A method of manufacturing a transparency, comprising: providing a single transparent panel comprising an exterior-facing No. 1 surface and an opposing No. 2 surface, wherein the single transparent panel is arranged between a frame; and forming a pattern at the No. 1 surface, wherein the pattern comprises a plurality of markings spaced at the No. 1 surface, wherein each of the plurality of markings comprises an abrasion, thereby leaving a visible marking at the No. 1 surface, wherein the pattern is formed at the No. 1 surface after the first transparent panel is arranged between the frame.

### Examples

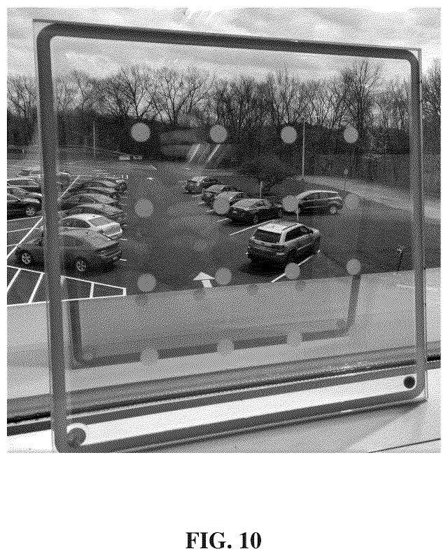

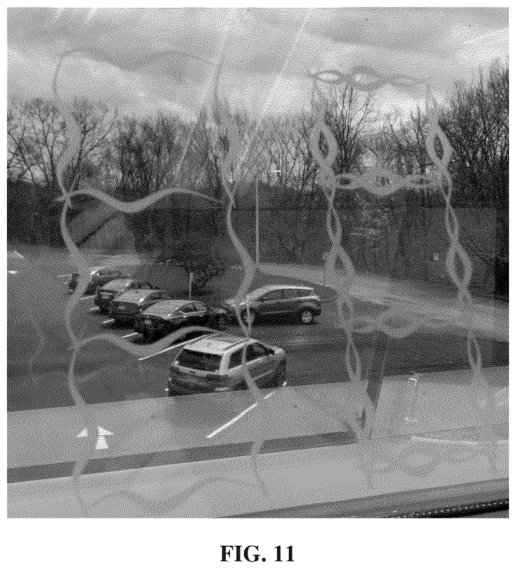

Referring to FIGS. 10-11, exemplary VIG units were produced. Two two-pane VIG units with 25 supports in the gap between the first panel and second panel were obtained, and the No. 1 surface of these VIG units was patterned using a CO₂ laser (manufactured by Trotec Laser (Marchtrenk, Austria)) at the No. 1 surface. The patterns of visible markings can be seen in FIGS. 10 (dot markings) and 11 (wavy-patterned markings). Surprisingly, no issues, such as damage to the VIG units, were found during or post patterning. The edges sealing the gap between the first and second panels, which were formed before application of the CO₂ laser, were not affected, contrary to the expected effect of performing the same patterning but using an acid etching technique. The transparent panels of the VIG unit remained intact with no signs of structural fracturing. As can be seen in FIGS. 10-11, the patterns were clearly visible.

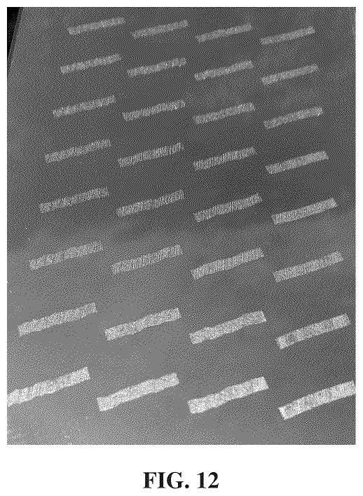

Referring to FIG. 12, an example of the surface patterned where the No. 1 surface was coated as shown. That surface was patterned by removing at least a portion of the coating using a diode laser (λ=390 nm).

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A window comprising:
a first transparent panel comprising an exterior-facing No. 1 surface and an opposing No. 2 surface,
a second transparent panel comprising an interior-facing No. 4 surface and an opposing No. 3 surface, wherein the first transparent panel and the second transparent panel are spaced apart from one another by a gap,
wherein the No. 1 surface comprises a pattern comprising a plurality of markings spaced at the No. 1 surface, wherein each of the plurality of markings comprise an abrasion, thereby leaving a visible marking at the No. 1 surface.

2. The window of claim 1, wherein the abrasions are laser-induced markings formed by applying a laser beam to the No. 1 surface to remove at least a portion of material of the No. 1 surface or produce microcracks beneath the No. 1 surface.

3. The window of claim 1, wherein the abrasions are formed by sandblasting the No. 1 surface to remove at least a portion of material of the No. 1 surface.

4. The window of claim 1, wherein the abrasions are formed by removing at least a portion of material of the No. 1 surface.

5. The window of claim 1, wherein the abrasions are formed by producing microcracks beneath the No. 1 surface.

6. The window of claim 1, wherein the No. 1 surface is an uncoated surface and/or a coated surface.

7. The window of claim 2, wherein the laser-induced markings are formed by a carbon dioxide laser.

8. The window of claim 2, wherein the laser beam has an energy density of from 0.5 J/cm² to 10 J/cm² at a location of a marking formed by the laser beam.

9. The window of claim 1, wherein each of the plurality of markings scatter incident electromagnetic radiation.

10. The window of claim 1, wherein the gap is sealed closed by an edge connecting the first panel and the second panel.

11. The window of claim 1, wherein the gap comprises a gas denser than air.

12. The window of claim 1, wherein the gap is evacuated to produce a vacuum.

13. The window of claim 12, further comprising a plurality of supports arranged in the gap to connect the first panel and the second panel.

14. The window of claim 13, wherein at least a portion of the plurality of markings are formed between locations in which the plurality of supports contact the first panel.

15. The window of claim 13, wherein at least a portion of the plurality of markings are formed at locations in which the plurality of supports contact the first panel.

16. The window of claim 1, wherein the first panel is a component of a building integrated photovoltaic (BIPV) component.

17. The window of claim 1, wherein the window is arranged in a frame of an architectural structure with the exterior-facing No. 1 surface arranged as an exterior surface of the architectural structure.

18. The window of claim 2, wherein the gap is sealed closed by an edge connecting the first panel and the second panel, wherein the plurality of markings are formed by applying the laser beam to the No. 1 surface after the gap is sealed closed.

19. The window of claim 1, wherein the plurality of markings are not formed by chemical etching unassisted by any photon enhanced reaction.

20. The window of claim 1, wherein the plurality of markings exhibit a 20° gloss value of less than 1.

21. The window of claim 1, wherein the pattern is spaced over the entire area of the No. 1 surface such that there is no four square inch area of the No. 1 surface without a marking of the plurality of markings.

22. The window of claim 1, wherein the first panel comprises glass and/or plastic.

23. The window of claim 1, further comprising at least one side light positioned to emit light at a side of the first transparent panel between the No. 1 surface and the No. 2 surface.

24. An architectural structure comprising the window of claim 1.

25. The architectural structure of claim 24, comprising a building comprising an opening, wherein the window is mounted in the opening with the exterior-facing No. 1 surface arranged as an exterior surface of the building.

26. A method of manufacturing a window, comprising:
providing an insulated transparency unit comprising a first transparent panel comprising an exterior-facing No. 1 surface and an opposing No. 2 surface and a second transparent panel comprising an interior-facing No. 4 surface and an opposing No. 3 surface, wherein the first transparent panel and the second transparent panel are spaced apart from one another by a gap; and
forming a pattern at the No. 1 surface, wherein the pattern comprises a plurality of markings spaced at the No. 1 surface, wherein each of the plurality of markings comprises an abrasion, thereby leaving a visible marking at the No. 1 surface.

27. The method of claim 26, wherein the patterning comprises removing at least a portion of material of the No. 1 surface or producing microcracks beneath the No. 1 surface using a laser beam.

28. The method of claim 26, further comprising:
sealing the gap closed by forming an edge connecting the first panel and the second panel,
wherein the plurality of markings are formed at the No. 1 surface after the gap is sealed closed.

29. The method of claim 26, wherein the gap is filled with a gas denser than air.

30. The method of claim 26, wherein the gap comprises a vacuum.

31. A method of preventing bird collisions with an architectural substrate, comprising:
installing the window of claim 1 in an opening of an architectural substrate with the exterior-facing No. 1 surface arranged as an exterior surface of the architectural substrate.
